(19) United States
(12) Patent Application Publication
(10) Pub. No.: US 2019/0344362 A1
(43) Pub. Date: Nov. 14, 2019

(54) POCKET HOLE JIG, POCKET HOLE JIG KITS, AND METHODS

(71) Applicant: Taylor James Hall, Palatine, IL (US)

(72) Inventor: Taylor James Hall, Palatine, IL (US)

(73) Assignee: Nomis LLC, Palatine, IL (US)

(21) Appl. No.: 15/977,736

(22) Filed: May 11, 2018

(51) Int. Cl. B23B 47/28

(52) U.S. Cl. CPC B23B 47/28; B23B 2247/10

(57) ABSTRACT

A pocket hole jig that includes a stop collar alignment cavity for properly axially aligning a stop collar along a drill bit is provided. The pocket hole jig may be part of a kit that also includes the drill bit and a stop collar. Methods of using the pocket hole jig and pocket hole jig kit are provided.

### FIELD OF THE INVENTION

This invention generally relates to pocket hole jigs.

### BACKGROUND OF THE INVENTION

Pocket hole connections have become popular for connecting two different work pieces. The pocket hole is an angled hole through a first surface of a workpiece that has a larger diameter bore for receipt of the head of a screw that terminates in a smaller diameter bore that extends through another, typically perpendicular, surface of the workpiece. The smaller diameter bore allows the shank of the screw to extend through the second side of the workpiece and into the second workpiece that is abutted against the second side of the work piece.

Pocket hole jigs have been developed to assist in guiding a special pocket hole drill bit due to the angled orientation of the drill bit relative to the first surface of the workpiece. The pocket hole jig will have one or more drill guides that is an angled bore that will guide the drill bit during use.

Further, specialized drill bits are typically used. The drill bit typically has two separate cylindrical sections having different diameters to form the large and small diameter bores.

To prevent the user from undesirably drilling too far into the workpiece or not far enough, a stop collar is often attached to the drill bit. The stop collar will abut an abutment or stop formed by the pocket hole jig indicating that the proper depth hole has been drilled. This abutment further prevents the drill bit from undesirably drawing the drill bit in too deep.

In many instances, the user is required to use a measuring tape to position the stop collar axially along the longitudinal axis of the drill bit, e.g. from the tip of the drill bit that does the drilling. Alternatively, some drill bits come with markings added to the shank of the drill bit to indicate where the abutment side of the stop collar should be positioned. However, all of these methods provide a level of error and can be rather difficult to perform. Further, adding the markings to the drill bits themselves adds cost to the manufacturing of the drill bit. Further, if the drill bit becomes lost, then third party drill bits may not be able to be easy used with the pocket hole jig.

The present invention provides improvements over the current state of the art as it relates to pocket hole jigs and pocket hole jig kits.

### BRIEF SUMMARY OF THE INVENTION

In one embodiment, a pocket hole jig for use with a drill bit and a stop collar adjustably mountable along a longitudinal axis of the drill bit. The pocket hole jig includes a workpiece support surface, a drill guide, a stop collar alignment cavity, a drill bit abutment and a stop collar abutment. The drill guide extends between first and second ends through the body. The drill guide intersects the workpiece support surface at a non-parallel and non-perpendicular orientation relative to the workpiece support surface. The stop collar alignment cavity is sized to receive at least a portion of the drill bit therein. The stop collar abutment is positioned relative to the drill bit abutment such that with the drill bit axially abutting the drill bit abutment and the stop collar axially abutting the stop collar abutment, the stop collar may be affixed to the drill bit in a predetermined axial position along the longitudinal axis of the drill bit. This predetermined position corresponds to a desired length of the drill bit that will extend into the drill guide in use such that a predetermined length of the drill bit will extend out of the drill guide in use past the workpiece support surface.

In one embodiment, the stop collar alignment cavity is configured such that when the drill bit is axially abutted against the drill bit abutment, a first portion of the drill bit extends axially out of the stop collar alignment cavity and is exposed for mounting the stop collar to the drill bit.

In one embodiment, the drill bit abutment is located proximate a first end of the stop collar alignment cavity and the stop collar abutment is proximate a second end of the stop collar alignment cavity.

In one embodiment, the stop collar alignment cavity defines a longitudinal axis that is parallel to the longitudinal axis of the drill bit when the drill bit is inserted therein. The longitudinal axis of the stop collar alignment cavity is at a non-parallel and non-perpendicular orientation relative to a central axis defined by the drill guide.

In one embodiment, the stop collar alignment cavity is a trough formed in the workpiece support surface.

In one embodiment, the stop collar alignment cavity has a first length. The drill guide has a second length. The first length is greater than the second length.

In one embodiment, a body provides the workpiece support surface, the drill guide, the stop collar alignment cavity, the stop collar abutment and the drill bit abutment. The body may be formed from multiple components such as a plastic body member that includes metal inserts forming part of the drill guides.

In one embodiment, a pocket hole jig kit is provided. The kit includes a drill bit defining a longitudinal axis, a stop collar configured to be adjustably affixed along the longitudinal axis of the drill bit, and a pocket hole jig as outlined above.

In one embodiment, the pocket hole jig further includes a drilling abutment proximate the first end of the drill guide. The stop collar axially abuts the drilling abutment when the drill bit is positioned within the drill guide when the stop collar is affixed to the drill bit at the predetermined axial position along the longitudinal axis of the drill bit and a proper depth pocket hole has been drilled.

In one embodiment, the drill bit extends between a first end and a second end. The first end is an end that is engageable by a drill and the second end is configured for drilling a work piece. The second end has a first cylindrical portion having a first diameter and a second cylindrical portion having a second diameter, the second diameter being greater than the first diameter.

In one embodiment, the stop collar alignment cavity has a first portion sized and configured to receive the first portion of the drill bit and a second portion sized and configured to receive the second portion of the drill bit. The first and second portions have dimensions that correspond to the dimensions of the first and second cylindrical portions of the drill bit, respectively.

In one embodiment, the stop collar alignment cavity includes a radially extending step between the first and second portions. The stop collar alignment cavity includes an end wall with the first portion being positioned between the end wall and the radially extending step. At least one of the end wall and radially extending step provides the drill bit abutment.

In one embodiment, the stop collar alignment cavity is a trough formed in the workpiece support surface.

In an embodiment, a method of using a pocket hole jig is provided. The method includes inserting a drill bit within a stop collar alignment cavity of the pocket hole jig with the drill bit axially abutting a drill bit abutment. The pocket hole jig has a body including: the stop collar alignment cavity; a stop collar abutment; the drill bit abutment; a drill guide extending between a first end and a second end; a drill abutment proximate the drill guide; and a workpiece support surface which the drill guide intersects proximate the second end at a non-parallel and non-perpendicular orientation. The method includes abutting a stop collar against the stop collar abutment to axially align the stop collar along a longitudinal axis of the drill bit. The method includes attaching the stop collar to the drill bit. The method includes drilling a pocket hole into a workpiece using the drill bit inserted into the drill guide until the stop collar abuts the drilling abutment of the pocket hole jig.

In one embodiment, when the drill bit axially abuts the drill bit abutment, a first portion of the drill bit extends axially out of the alignment cavity and is exposed for mounting the stop collar to the drill bit.

In one embodiment, the drill bit has a first end and a second end opposite the first end, the second end being positioned within the alignment cavity and the first end being out of the alignment cavity when the drill bit is inserted in the alignment cavity in axial abutment with the drill bit abutment.

In one embodiment, the step of abutting the stop collar against the stop collar abutment includes inserting the first end and first portion of the drill bit through the stop collar and sliding the stop collar along the first portion of the drill bit until the stop collar axially abuts the second abutment.

In one embodiment, the drill guide intersects the workpiece support surface at a non-parallel and non-perpendicular orientation.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a pocket hole jig kit including a pocket hole jig, a drill bit and a stop collar;

FIG. 2 is a perspective illustration of the pocket hole jig kit with the drill bit inserted into the pocket hole jig;

FIG. 3 is a cross-sectional illustration of the pocket hole jig kit of FIG. 2;

FIG. 4 is a perspective bottom illustration of the pocket hole jig of FIG. 1;

FIG. 5 is a cross-sectional illustration of the pocket hole jig kit with the drill bit inserted into the stop collar alignment cavity; and

FIG. 6 is a cross-sectional illustration of the pocket hole jig kit in use.

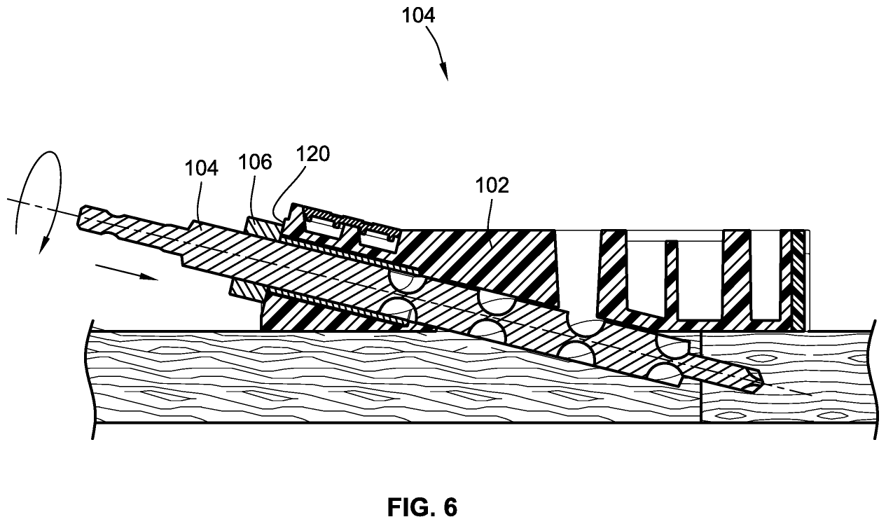

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

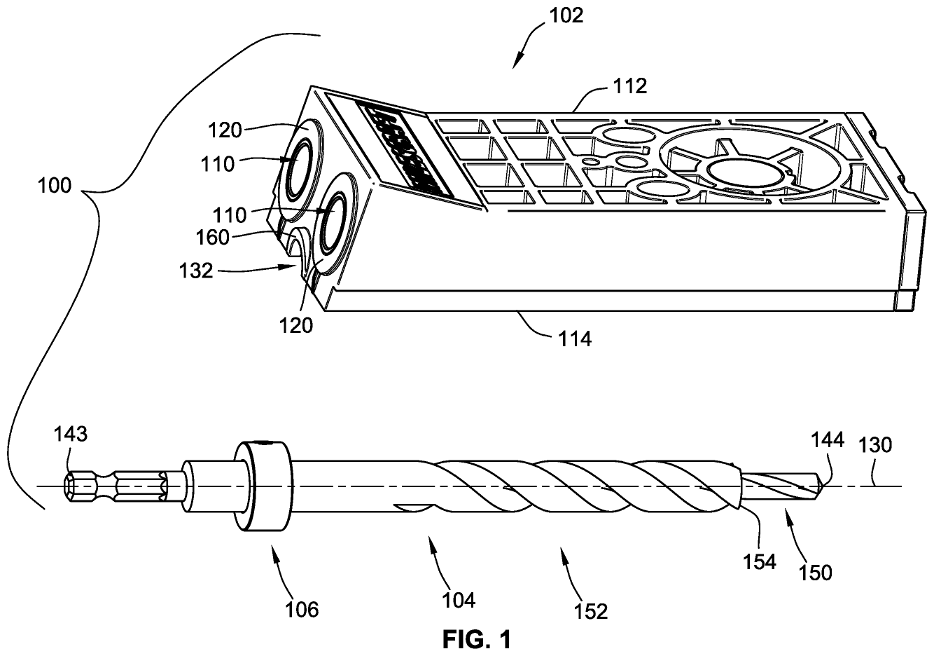

FIG. 1 illustrates a pocket hole jig kit 100 according to an embodiment of the invention. The pocket hole jig kit 100 is used to form pocket holes for receipt of a screw to connect two pieces of material, typically wood, together. The method of connecting two workpieces together using pocket holes and associated screws is generally known.

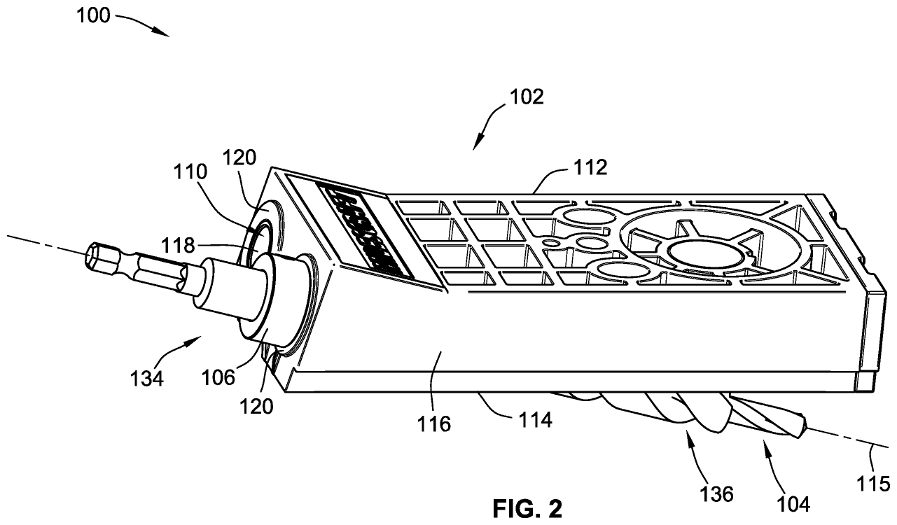

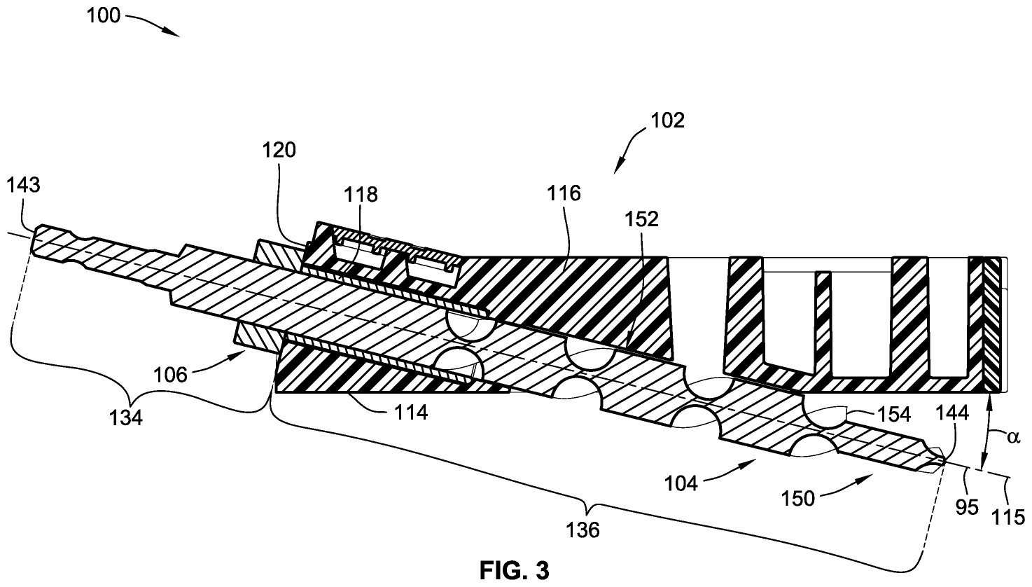

With reference to FIGS. 1-3, the pocket hole jig kit 100 includes a pocket hole jig 102, a drill bit 104 and a stop collar 106. The pocket hole jig 102 can be positioned on a surface of a workpiece in which the pocket hole will be drilled. The drill bit 104 is then guided by drill guides 110 provided by the pocket hole jig 102 to form angled holes within the workpiece.

The pocket hole jig 102 includes a body 112. The body 112 includes a workpiece support surface 114 that is generally planar and configured to rest on a workpiece, and particularly a surface of a workpiece in which the pocket hole will be drilled.

The body 112 provides the drill guides 110. The drill guides 110 are bores that have a centerline 115 that extend at a non-perpendicular and non-parallel angle a to the workpieces support surface 114 and are used to guide drill bit 104 during drilling operations. The drill guides 110 extend between first and second ends through the body 112 and intersect the workpiece support surface. Typically, the drill bit 104 is received in the first end and exits through the second end. In this embodiment, the body 112 is formed from multiple components that are assembled. The body 112 includes a main plastic body member 116 that supports metal drill guide inserts 118. The metal drill guide inserts 118 allow the use of plastic as the main portion of the body 112 but provide sufficient durability for rotatably supporting the drill bit 104 in use. Drill guides 110 with or without inserts are contemplated.

The present embodiment has two drill guides 110 that have a same angle a relative to workpiece support surface 114. However, other embodiments could have more or fewer drill guides 110. Further, in embodiments with multiple drill guides, it is possible for different ones of the drill guides to extend at different angles relative to the workpiece support surface.

To drill into the workpiece, the drill bit 104 must extend axially out of the body 112 and beyond the workpiece support surface 114. Further the distance, the drill bit 104 extends beyond the workpiece support surface 114 should be consistent so that the pocket hole that is formed extends the appropriate depth into the workpiece. For example, if the drill bit 104 extends to far into a workpiece it may pierce entirely through the workpiece such that there is nothing left in the workpiece for the head of a screw to grip when holding two pieces of wood together or even provide too little material left such that the screw will simply pull through the workpiece. Alternatively, if the drill bit 104 does not drill deep enough into the workpiece, the screw may not be able to extend far enough into the second workpiece that is being connected to the workpiece that includes the pocket hole such that the joint formed between the two workpieces is weak and there is the risk of tearing the screw out of the second workpiece.

The stop collar 106 affixed to the drill bit 104 and will axially abut a drilling abutment 120 which is proximate the first end of the drill guide 110 when the proper drilling depth has been achieved. It will prevent the drill bit 104 from drilling too deep due to interference with the drilling abutment 120. It will also provide an indication if the hole has not been fully drilled if the stop collar 106 has not contacted the drilling abutment 120 (e.g. if the user sees a gap therebetween). In the illustrated embodiment, the drilling abutment 120 is a raised annular projection formed on an outer surface of plastic body member 116. However, the drilling abutment 120 could simply be provided by a flat exterior surface of the body 112 or alternatively could be provided by, at least in part, the metal drill guide inserts 118.

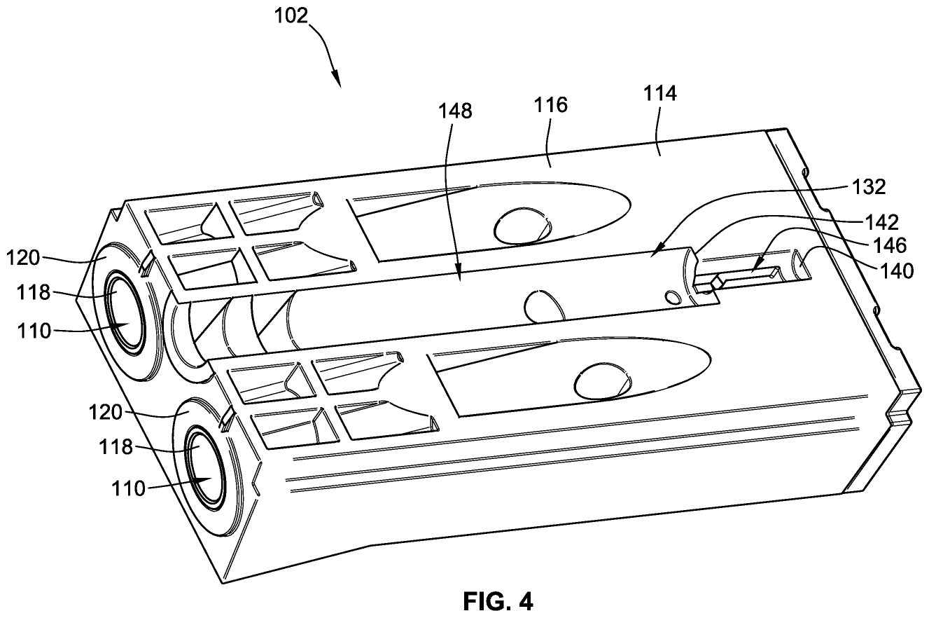

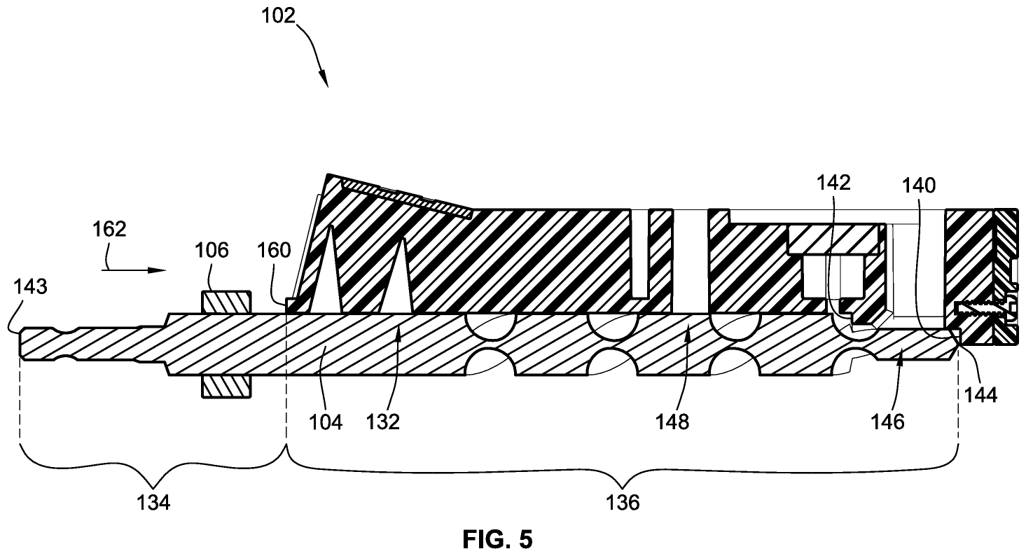

To properly set the position of the stop collar 106 along a longitudinal axis 130 of the drill bit 104 (typically central axis), the pocket hole jig 104 includes a stop collar alignment cavity 132 (see e.g. FIGS. 4 and 5). The stop collar alignment cavity 132 is configured to allow a first portion 134 of drill bit 104 proximate a first end 143 to extend axially out of the body 112 while a second portion 136 proximate second end 144 is positioned within the stop collar alignment cavity 132. The first portion 134 of the drill bit 104 is the portion to which the stop collar 106 will be affixed, e.g. by sliding the stop collar 106 over the drill bit 104 with the drill bit 104 passing through the central opening of the stop collar 106. It will also, typically, be at least part of the drill bit 104 that is engaged by a drill to transfer torque to the drill bit 104.

A drill bit abutment axially positions the drill bit 104 within the stop collar alignment cavity 132. In this embodiment, a pair of drill bit abutments 140, 142 are provided. The first drill bit abutment 140 is an axial end wall forming a closed end of the stop collar alignment cavity 132. Second end 144 of drill bit 104 can abut this end wall such that the user knows that the drill bit 104 is properly axially inserted into the stop collar alignment cavity 132. The second drill bit abutment 142 is a radially extending wall that is formed between first and second cylindrical sections 146, 148 of the stop collar alignment cavity 132. The first and second sections 146, 148 correspond to first and second cylindrical drilling portions 150, 152 of drill bit 104.

Pocket hole drill bits typically include these two separate diameter cylindrical portions 150, 152 to allow drilling two separate diameter portions of the pocket hole in the workpiece. The smaller diameter portion 150 is used for drilling a pilot hole for the shank/threads of the screw used in the connection and the larger diameter portion 152 is used to drill a large hole that receives the head of the screw. The resulting change in diameter provides an abutment in the workpiece that head of the screw will axially draw down against when securing two workpieces together.

The difference in diameter between the cylindrical portions 150, 152 creates a radially extending wall 154 or step in the drill bit 104. This radially extending wall can axially abut the second drill bit abutment 142, e.g. a radially extending wall formed by body 112.

The length of the stop collar alignment cavity 132 and/or configuration of the drill bit abutments 140, 142 is such that the intersection between the first and second portions 134, 136 aligns with a stop collar abutment 160. The stop collar abutment is radially offset from the stop collar alignment cavity 132. As such, the user can simply slide the stop collar 106 along the first portion 134 of the drill bit illustrated by arrow 162 in FIG. 5 until the stop collar 106 axially abuts the stop collar abutment 160. With the stop collar 106 in axial abutment with the stop collar abutment 160, the user can affix the stop collar 106, such as with a set screw, along the longitudinal axis 130 of the drill bit 104 such that the stop collar 106 is in the desired axial position for drilling operations, e.g. such that a desired length of the drill bit 104 will extend past the workpiece support surface 114 in use. The length of the stop collar alignment cavity 132 is greater than the length of the drill guides 110.

It is noted that the stop collar abutment 160 is provided by an outer surface, or an end of the body 112. Further, it is noted that the drill bit abutments 140, 142 and the stop collar abutment 160 axially face the same direction along the central axis of the stop collar alignment cavity 132. Further, the central axis of the stop collar alignment cavity 132 extends at a non-parallel and non-perpendicular orientation relative to the centerline 115 of the drill guides 110.

While the illustrated embodiment includes drill bit abutments 140, 142 formed by the body 112, it is possible that the stop collar alignment cavity 132 is simply a through bore formed by the pocket hole jig 102. The drill bit abutment of the pocket hole jig 102 could be provided by a surface that rests up against the body 112 to close the through bore. The end of the drill bit 104 can then simply abut the flat surface to properly axially position the drill bit 104 relative to the stop collar abutment 160.

In this embodiment, the stop collar alignment cavity 132 is in the form of a trough formed in the bottom of the body 112 and particularly in the workpiece support surface 114. In other embodiments, the stop collar alignment cavity 132 could be in the form of a bore formed by the body 112. However, by using a trough there is less risk of debris being located in the stop collar alignment cavity 132 in use that could inhibit proper location of the drill bit 104 therein, which ultimately could affect proper alignment of the stop collar 106 relative to the drill bit 104. In this embodiment, the drill bit 104 is insertable into the trough in a direction that is perpendicular to the longitudinal axis 130 (e.g. axis of rotation) of the drill bit 104.

As such, the present invention provides a measureless arrangement for positioning the stop collar 106 axially along the longitudinal axis 130 of the drill bit. There is no need to use a measuring tape or to attempt to align a stop collar 106 with markings on the drill bit 104 for properly positioning the stop collar 106. These prior methods for positioning the stop collar 106 provided the possibility for error and made the process of positioning the stop collar 106 unnecessarily difficult. Further, it eliminates the need to add markings to the drill bit as well as allows third party drill bits to be used that do not include such markings.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A pocket hole jig for use with a drill bit and a stop collar adjustably mountable along a longitudinal axis of the drill bit, the pocket hole jig comprising:
a workpiece support surface;
a drill guide extending between first and second ends through the body, the drill guide intersecting the workpiece support surface at a non-parallel and non-perpendicular orientation relative to the workpiece support surface;
a stop collar alignment cavity sized to receive at least a portion of the drill bit therein;
a drill bit abutment;
a stop collar abutment positioned relative to the drill bit abutment such that with the drill bit axially abutting the drill bit abutment and the stop collar axially abutting the stop collar abutment, the stop collar may be affixed to the drill bit in a predetermined axial position along the longitudinal axis of the drill bit.

2. The pocket hole jig of claim 1, wherein the stop collar alignment cavity is configured such that when the drill bit is axially abutted against the drill bit abutment, a first portion of the drill bit extends axially out of the stop collar alignment cavity and is exposed for mounting the stop collar to the drill bit.

3. The pocket hole jig of claim 1, wherein the drill bit abutment is located proximate a first end of the stop collar alignment cavity and the stop collar abutment is proximate a second end of the stop collar alignment cavity.

4. The pocket hole jig of claim 1, wherein the stop collar alignment cavity defines a longitudinal axis that is parallel to the longitudinal axis of the drill bit when the drill bit is inserted therein, the longitudinal axis of the stop collar alignment cavity being at a non-parallel and non-perpendicular orientation relative to a central axis defined by the drill guide.

5. The pocket hole jig of claim 1, wherein the stop collar alignment cavity is a trough formed in the workpiece support surface.

6. The pocket hole jig of claim 1, wherein the stop collar alignment cavity has a first length, the drill guide having a second length, the first length being greater than the second length.

7. The pocket hole jig of claim 1, a body providing the workpiece support surface, the drill guide, the stop collar alignment cavity, the stop collar abutment and the drill bit abutment.

8. A pocket hole jig kit comprising:
a drill bit defining a longitudinal axis;
a stop collar configured to be adjustably affixed along the longitudinal axis of the drill bit;
a pocket hole jig of claim 1, the pocket hole jig further including a drilling abutment proximate the first end of the drill guide, the stop collar axially abutting the drilling abutment when drill bit is positioned within the drill guide when the stop collar is affixed to the drill bit at the predetermined axial position along the longitudinal axis of the drill bit.

9. The pocket hole jig kit of claim 8, wherein the drill bit extends between a first end and a second end, the first end being an end that is engageable by a drill and the second end configured for drilling a work piece, the second end having a first cylindrical portion having a first diameter and a second cylindrical portion having a second diameter, the second diameter being greater than the first diameter.

10. The pocket hole jig kit of claim 9, wherein the stop collar alignment cavity has a first portion sized and configured to receive the first portion of the drill bit and a second portion sized and configured to receive the second portion of the drill bit.

11. The pocket hole jig kit of claim 10, wherein the stop collar alignment cavity includes a radially extending step between the first and second portions, the stop collar alignment cavity includes an end wall with the first portion being positioned between the end wall and the radially extending step, at least one of the end wall and radially extending step providing the drill bit abutment.

12. The pocket hole jig kit of claim 9, wherein the stop collar alignment cavity is a trough formed in the workpiece support surface.

13. A method of using a pocket hole jig 1 of claim 1, comprising:
inserting a drill bit within the stop collar alignment cavity of the pocket hole jig with the drill bit axially abutting the drill bit abutment;
abutting a stop collar against the stop collar abutment to axially align the stop collar along a longitudinal axis of the drill bit;
attaching the stop collar to the drill bit; and
drilling a pocket hole into a workpiece using the drill bit inserted into the drill guide until the stop collar abuts the drilling abutment of the pocket hole jig.

14. The method of claim 13, wherein when the drill bit axially abuts the drill bit abutment, a first portion of the drill bit extends axially out of the alignment cavity and is exposed for mounting the stop collar to the drill bit.

15. The method of claim 14, wherein the drill bit has a first end and a second end opposite the first end, the second end being positioned within the alignment cavity and the first end being out of the alignment cavity when the drill bit is inserted in the alignment cavity in axial abutment with the drill bit abutment.

16. The method of claim 15, wherein the step of abutting the stop collar against the stop collar abutment includes inserting the first end and first portion of the drill bit through the stop collar and sliding the stop collar along the first portion of the drill bit until the stop collar axially abuts the second abutment.
